(19) United States
(12) Patent Application Publication
(10) Pub. No.: US 2026/0093551 A1
(43) Pub. Date: Apr. 2, 2026

(54) SYSTEM AND METHOD FOR DETERMINING EXECUTION PERFORMANCE OF GENERATIVE ARTIFICIAL INTELLIGENCE (AI) MODELS

(71) Applicant: SISA Information Security Pvt Ltd, Bengaluru (IN)

(72) Inventors: Anjan Krishnamurthy, Bangalore (IN); Mahesh R, Bangalore (IN); Renju Varghese Jolly, Bangalore (IN)

(21) Appl. No.: 18/899,306

(22) Filed: Sep. 27, 2024

(51) Int. Cl. G06F 9/50

(52) U.S. Cl. CPC G06F 9/505

(57) ABSTRACT

A system and method for determining execution performance of one or more generative artificial intelligence (AI) models are disclosed. The system comprises a workflow management subsystem, a data obtaining subsystem, a context retrieval subsystem, a score-generating subsystem, and a performance detection subsystem. The system is configured to evaluate at least one of: a correctness score, a pertinence score, a similarity score, a profanity score, a vulnerability score, and a perplexity score, based on comparing first output data (actual output) generated by the one or more generative AI models with input data and second output data (expected output). Based on these various metrics scores, the system is configured to generate a performance report for determining the execution performance of the one or more generative AI models.

### TECHNICAL FIELD

Embodiments of the present disclosure relate to artificial intelligence (AI) evaluation and more particularly relates to a computer-implemented system and method for determining execution performance of one or more generative artificial intelligence (AI) models.

### BACKGROUND

In recent years, a rapid development of artificial intelligence (AI) models and machine learning (ML) models, extensive language models (LLMs), has led to their widespread adoption across various industries. The AI models and the ML models are being deployed in critical applications, such as customer service, healthcare, financial services, and content generation, where accuracy, relevance, and security of generated outputs are vital for user trust and operational efficiency. However, despite their growing use, the AI models and the ML models suffer from several significant challenges, including performance evaluation, contextual relevance, security vulnerabilities, and content appropriateness.

One foremost challenge lies in the evaluation of an execution performance of the AI models. Existing systems primarily focus on limited metrics such as accuracy and precision, but the existing systems fail to provide a comprehensive assessment of the AI model's ability to handle real-world inputs. The existing systems lack the ability to evaluate critical aspects such as the correctness of the AI model's responses to the input data, the relevance of the generated output, and deviations from expected behavior. Furthermore, these evaluation techniques are not dynamic, meaning they struggle to adapt to evolving input data and changing AI model configurations.

Another significant drawback in existing systems are lack of robust mechanisms for detecting security vulnerabilities, such as prompt injection or jailbreaking attacks. The jailbreaking attacks exploit weaknesses in the AI models by manipulating the input data to generate harmful, inappropriate, and unintended outputs. While security measures exist for software applications, there are few sophisticated tools capable of detecting and preventing such vulnerabilities in the AI models, especially those based on large-scale neural networks.

Additionally, content relevance is a growing concern, especially with the AI models generating text or other content in customer-facing applications. Many AI models produce outputs that contain inappropriate language, toxic behavior, or even profanity, which leads to significant reputational and legal issues for organizations. Existing profanity or toxicity detection systems are often rudimentary, relying on keyword-based filters that fail to capture the nuanced or contextual nature of offensive language.

The contextual relevance of the AI-generated outputs is also an area where existing technologies struggle. While the AI models provide correct answers in some scenarios, they frequently fail to align their outputs with a context provided by the user or external datasets, leading to misleading or irrelevant outputs. This is particularly problematic when the AI models are deployed in workflows requiring high levels of contextual understanding, such as legal applications, medical applications, and financial applications.

In the existing technology, evaluate large language models (LLMs) for quality and responsibility developed by Amazon Web Services (AWS), provides a framework called Amazon SageMaker Clarify for evaluating foundation models (FMs) and LLMs. This existing technology provides evaluation across multiple dimensions including accuracy, robustness, bias, toxicity, and factual knowledge, utilizing industry-standard metrics and datasets. This existing technology integrates with AWS services and Machine Learning Operations (MLOps) workflows and includes an open-source Foundation Model Evaluations Library (FMEval) for code-first evaluation experiences. The framework is able to evaluate both AWS-hosted and third-party LLMs, allows for customizable prompt datasets and evaluation algorithms, and provides multiple output formats for analysis and operationalization.

However, the disclosed existing technology lacks comprehensive evaluation metrics for assessing critical aspects such as correctness and output data pertinence determination. The disclosed existing technology also does not provide a flexible, platform-agnostic dashboard solution that accommodates various workflow scenarios. The existing technology is tightly coupled with AWS services, limiting its applicability in diverse environments. Additionally, the existing technology does not provide granular control over the evaluation process or incorporate advanced techniques for detecting subtle issues in the AI model outputs. The system's reliance on pre-trained models for certain assessments may limit its adaptability to rapidly evolving AI model challenges. Furthermore, the existing technology does not emphasize continuous, real-time evaluation capabilities, which are crucial for monitoring the AI models in production environments where performance may drift over time. These limitations restrict the existing technology's ability to provide a holistic, adaptable, and platform-independent solution for comprehensive the AI model evaluation.

There are various technical problems with the execution performance of the AI models in the prior art. In the existing technology, the evaluation of the AI models is often limited in scope and depth, failing to capture the full range of potential issues that arise in real-world applications. One significant problem is the lack of comprehensive metrics that accurately assess the correctness of the AI-generated outputs to the input data. This leads to situations where the AI models may produce plausible-sounding but factually incorrect or irrelevant responses. Additionally, existing systems struggle to effectively detect and quantify subtle forms of bias, hallucination, or inconsistency in the AI-generated outputs, which leads to unreliable or potentially harmful results when deployed in the real-world applications. Furthermore, there is a notable absence of standardized, platform-independent tools that provide consistent evaluation across different AI model architectures and deployment environments. This lack of standardization makes the existing systems challenging for organizations to compare and benchmark different AI models effectively.

Therefore, there is a need for a system to address the aforementioned issues by determining the execution performance of the AI models. There is a need for the system that provide a comprehensive, multi-dimensional evaluation framework that able to accurately assess various aspects of the AI model's performance. Additionally, there is a need for the system that can evaluate the AI models across different architectures and deployment scenarios, providing consistent and comparable results.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computer-implemented system for determining an execution performance of one or more generative artificial intelligence (AI) models is disclosed.

In an embodiment, the computer-implemented system comprises one or more servers. The one or more servers comprise one or more hardware processors and a memory unit. The memory unit is operatively connected to the one or more hardware processors. The memory unit comprises a set of computer-readable instructions in form of a plurality of subsystems, configured to be executed by the one or more hardware processors. The plurality of subsystems comprises a workflow management subsystem, a data obtaining subsystem, a context retrieval subsystem, a score-generating subsystem, a performance detection subsystem, a predictability subsystem, and a feedback loop subsystem.

In another aspect, the workflow management subsystem is configured to operate the one or more generative AI models within a controlled workflow by providing input data for obtaining first output data. The controlled workflow is a Retrieval Augmented Generation (RAG) workflow. The controlled workflow is configured to retrieve context information from the input data during the execution of the one or more generative AI models and store it in one or more databases. The controlled workflow is configured to assign one or more ranks to the retrieved context information for prioritizing optimal context information for generating one or more responses. The controlled workflow is configured to generate the one or more responses based on at least one of: the provided input data and the retrieved context information.

In yet another aspect, the data obtaining subsystem is configured to obtain at least one of: the input data, the first output data, and second output data from at least one of: the one or more generative AI models, one or more users, and historic system data. The input data comprises one or more of: text data, numerical data, images, audio data, and video data, provided to the one or more generative AI models for processing. The first output data comprises results generated by the one or more generative AI models in response to the input data, including one or more at least one of: predicted text, classified categories, generated images, audio transcriptions, and predicted numerical values. The second output data comprises at least one of: a set of expected results and ground truth data, comprises at least one of: predetermined data and derived data from historical data, used to evaluate the first output data provided by the one or more generative AI models.

In another aspect, the context retrieval subsystem is configured to retrieve the context information from at least one of: the input data and the second output data stored in one or more databases, based on one or more queries provided to the one or more generative AI models. The context retrieval subsystem is configured to store the context information, the input data, the second output data, and the one or more queries in a form of one or more vector embeddings. The context retrieval subsystem is configured with a cosine similarity model. The cosine similarity model is configured to retrieve the context information based on determining a cosine angle between the one or more vector embeddings associated with the one or more queries and the one or more vector embeddings associated with the input data.

In yet another aspect, the score-generating subsystem comprises a correctness score generation subsystem, an output data pertinence determination subsystem, an output data deviation detection subsystem, a profanity detection subsystem, and a vulnerability detection subsystem. The correctness score generation subsystem is configured to determine the correctness of the one or more generative AI models based on performing a comparative analysis between the first output data against the second output data using at least one of: a pre-trained embedding model and a pre-trained X-encoder model for generating a correctness score. The pre-trained embedding model uses the cosine similarity model to identify a contextual relationship between the first output data and the second output data for generating a semantic similarity score. The pre-trained X-encoder model is configured to identify an intricate relationship between the first output data and the second output data for generating an X-encoder score. The correctness score generation subsystem is further configured to regulate the semantic similarity score and the X-encoder score using a weighted combination based on a similarity threshold determined by a semantic similarity function. If the correctness score is one of: within a predefined correctness threshold score and equal to the predefined correctness threshold score, the computer-implemented system determines that the first output data is apposite to the provided input data. If the correctness score exceeds the predefined correctness threshold score, the computer-implemented system determines that the first output data is inapt with the provided input data.

In another aspect, the output data pertinence determination subsystem is configured to determine a pertinence of the first output data for the provided input data to the one or more generative AI models using at least one of: a pre-trained zero-shot classifier and a clustering process, to generate a pertinence score. The output data pertinence determination subsystem is configured to map the one or more vector embeddings associated with the input data and the one or more vector embeddings associated with the first output data into a clustered space to determine a distance between the input data and the first output data for generating the pertinence score. If the pertinence score is one of: within a predefined pertinence threshold score and equal to the predefined pertinence threshold score, the computer-implemented system determines that the first output data is at least one of: optimal correlated and neutral, with the provided input data. If the pertinence score exceeds the predefined pertinence threshold score, the computer-implemented system determines that the first output data is in contradiction to the provided input data.

In yet another aspect, the output data deviation detection subsystem is configured to identify a deviation of the first output data generated by the one or more generative AI models from the provided input data based on at least of: a) the comparative analysis between the first output data and the second output data, and b) the comparative analysis between the first output data and the context information, for generating a similarity score. The output data deviation detection subsystem is configured to identify a deviation of the output data based on comparing the similarity score with a predefined similarity threshold score. If the similarity score is one of: within the predefined similarity threshold score and equal to the predefined similarity threshold score, the computer-implemented system determines that the first output data is in line with the input data. If the similarity score exceeds the predefined similarity threshold score, the computer-implemented system determines that the first output data is deviated from the provided input data.

In another aspect, the profanity detection subsystem is configured to analyze the first output data to identify profanity data in the first output data using one or more machine learning models trained on pre-defined profanity data for generating a profanity score for the first output data. The pre-defined profanity data is pre-processed to convert into one or more profanity data vectors. The profanity detection subsystem is configured to assign each profanity data vector of the one or more profanity data vectors in relation to one or more profanity classifications. The profanity detection subsystem is configured to classify the first output data into the one or more profanity classifications by comparing the one or more vector embeddings associated with the first output data against the one or more profanity data vectors. The profanity detection subsystem is configured to generate the profanity score based on a number of one or more vector embeddings associated with the first output data matched with the one or more profanity data vectors associated with the one or more profanity classifications. If the profanity score is one of: within a predefined profanity threshold score and equal to the predefined profanity threshold score, the computer-implemented system determines that the first output data is tolerable. If the profanity score exceeds the predefined profanity threshold score, the computer-implemented system determines that the first output data contains exceptionable profanity data and triggers for at least one of: flagging and filtering, the profanity data. The one or more machine learning models comprise an accurate gradient shallow decision tree model. The accurate gradient shallow decision tree model is configured to identify the profanity data in the first output data based on the one or more profanity data vectors.

In yet another aspect, the vulnerability detection subsystem is configured to determine a susceptibility of the first output data based on comparing the first output data with one or more jailbreaking test cases for generating a vulnerability score. If the vulnerability score is one of: within a predefined vulnerability threshold score and equal to the predefined vulnerability threshold score, the computer-implemented system determines that the one or more generative AI models are benign. If the vulnerability score exceeds the predefined vulnerability threshold score, the computer-implemented system determines that the one or more generative AI models are malignant.

In another aspect, the performance detection subsystem is configured to execute a comparative analysis between at least one of: the correctness score, the pertinence score, the similarity score, the profanity score, and the vulnerability score against respective threshold scores to generate a performance report for determining execution performance of the one or more generative AI models. The threshold scores comprise at least one of: the predefined correctness threshold score, the predefined pertinence threshold score, the predefined similarity threshold score, the predefined profanity threshold score, and the predefined vulnerability threshold score. The performance detection subsystem is configured to generate the performance report in form at least one of: radar charts, bar charts, line charts, pie charts; scatter plots, and bubble charts. The generated performance report comprises one or more actionable recommendations for optimizing the performance of the one or more generative AI models based on identified at least one of: the correctness score, the pertinence score, the similarity score, the profanity score and the vulnerability score.

In yet another aspect, the predictability subsystem is configured determine a probability of each consecutive action of one or more actions to execute in the first output data using an n-gram language model to evaluate the execution performance of one or more generative artificial intelligence (AI) models. The predictability subsystem is configured to train the n-gram language model on the input data to determine the probability of each consecutive action of the one or more actions using the trained n-gram language model to generate a perplexity score. The predictability subsystem is configured to normalize the generated perplexity score to a defined perplexity range, if the perplexity score is one of: within a predefined perplexity threshold score of the defined perplexity range and equal to the predefined perplexity threshold score of the defined perplexity range, the computer-implemented system determines that the probability of predicting each consecutive action of one or more actions is superior. If the perplexity score exceeds the predefined perplexity threshold score of the defined perplexity range, the computer-implemented system determines the probability of predicting each consecutive action of one or more actions is inferior.

In another aspect, the feedback loop subsystem is configured to continuously re-evaluate the one or more generative AI models based on real-time at least one of: the input data, AI model configurations, and evaluation results, for generating real-time performance reports.

In accordance with another embodiment of the present disclosure, a computer-implemented method for determining the execution performance of the one or more generative AI models is disclosed. In the first step, the computer-implemented method includes operating, by the one or more servers through the workflow management subsystem, the one or more generative AI models within the controlled workflow by providing the input data to obtain the first output data. In the next step, the computer-implemented method includes obtaining, by the one or more servers through the data obtaining subsystem, at least one of: the input data, the first output data, and the second output data from at least one of: the one or more generative AI models, the one or more users, and the historic system data.

In the next step, the computer-implemented method includes retrieving, by the one or more servers through the context retrieval subsystem, the context information from at least one of: the input data and the second output data stored in the one or more databases, based on the one or more queries provided to the one or more generative AI models. In the next step, the computer-implemented method includes generating, by the one or more servers through the score-generating subsystem, comprises: determining, by the correctness score generation subsystem, the correctness of the one or more generative AI models based on performing the comparative analysis between the first output data against the second output data using at least one of: the pre-trained embedding model and the pre-trained X-encoder model for generating the correctness score; determining, by the output data pertinence determination subsystem, the pertinence of the first output data for the provided input data to the one or more generative AI models using at least one of: the pre-trained zero-shot classifier and a clustering process, to generate the pertinence score; identifying, by the output data deviation detection subsystem, the deviation of the first output data generated by the one or more generative AI models from the provided input data based on at least one of: the comparative analysis between the first output data and the second output data; and the comparative analysis between the first output data and the context information, for generating a similarity score; analyzing, by the profanity detection subsystem, the first output data to identify profanity data in the first output data using one or more machine learning models trained on pre-defined profanity data for generating the profanity score for the first output data; and determining, by the vulnerability detection subsystem, the susceptibility of the first output data based on comparing the first output data with the one or more jailbreaking test cases for generating the vulnerability score.

In the next step, the computer-implemented method includes executing, by the one or more servers through the performance detection subsystem, the comparative analysis between at least one of: the correctness score, the pertinence score, the similarity score, the profanity score, and the vulnerability score against the respective threshold scores to generate the performance report to determine execution performance of the one or more generative AI models. In the next step, the computer-implemented method includes determining, by the one or more servers through the predictability subsystem, the probability of each consecutive action of one or more actions to execute in the first output data using the n-gram language model to evaluate the execution performance of the one or more generative AI models. In the next step, the computer-implemented method includes re-evaluating, by the one or more servers through the feedback loop subsystem, the one or more generative AI models based on real-time at least one of: the input data, the AI model configurations, and the evaluation results, to generate the real-time performance reports.

In accordance with another embodiment of the present disclosure, a non-transitory computer-readable storage medium storing computer-executable instructions that, when executed by the one or more hardware processors, cause the one or more hardware processors to perform operations for determining execution performance of one or more generative AI models, the operations comprising: a) operating the one or more generative AI models within the controlled workflow by providing the input data to obtain the first output data, b) obtaining at least one of: the input data, the first output data, and the second output data from at least one of: the one or more generative AI models, the one or more users, and the historic system data, c) retrieving the context information from at least one of: the input data and the second output data stored in the one or more databases, based on the one or more queries provided to the one or more generative AI models, d) determining the correctness of the one or more generative AI models based on performing the comparative analysis between the first output data against the second output data using at least one of: the pre-trained embedding model and the pre-trained X-encoder model for generating the correctness score, e) determining the pertinence of the first output data for the provided input data to the one or more generative AI models using at least one of: the pre-trained zero-shot classifier and the clustering process, to generate the pertinence score, f) identifying the deviation of the first output data generated by the one or more generative AI models from the provided input data based on at least one of: the comparative analysis between the first output data and the second output data, and the comparative analysis between the first output data and the context information, for generating a similarity score, g) analyzing the first output data to identify the profanity data in the first output data using the one or more machine learning models trained on pre-defined profanity data for generating the profanity score for the first output data, h) determining the susceptibility of the first output data based on comparing the first output data with the one or more jailbreaking test cases for generating the vulnerability score, and i) executing the comparative analysis between at least one of: the correctness score, the pertinence score, the similarity score, the profanity score, and the vulnerability score against respective the threshold scores to generate the performance report to determine execution performance of the one or more generative AI models.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture of a computer-implemented system for determining an execution performance of one or more generative artificial intelligence (AI) models, in accordance with an embodiment of the present disclosure;

FIG. 2A illustrates an exemplary block diagram of the computer-implemented system as shown in FIG. 1 for determining the execution performance of the one or more generative AI models, in accordance with an embodiment of the present disclosure;

FIG. 2B illustrates an exemplary block diagram of a score-generating subsystem, in accordance with an embodiment of the present disclosure;

FIG. 2C illustrates an exemplary schematic diagram of a correctness score generation subsystem, in accordance with an embodiment of the present disclosure;

FIG. 2D illustrates an exemplary schematic diagram of an output data pertinence determination subsystem, in accordance with an embodiment of the present disclosure;

FIG. 2E illustrates an exemplary schematic diagram of an output data deviation detection subsystem, in accordance with an embodiment of the present disclosure;

FIG. 2F illustrates an exemplary schematic diagram of a profanity detection subsystem, in accordance with an embodiment of the present disclosure;

FIG. 2G illustrates an exemplary schematic diagram of a vulnerability detection subsystem, in accordance with an embodiment of the present disclosure;

FIG. 3 illustrates an exemplary user/client workflow architecture, in accordance with an embodiment of the present disclosure;

FIG. 4 illustrates an exemplary user/client and the computer-implemented system setup workflow architecture, in accordance with an embodiment of the present disclosure;

FIG. 5 illustrates an exemplary workflow architecture depicting the computer-implemented system as a website, in accordance with an embodiment of the present disclosure;

FIG. 6 illustrates an exemplary flow chart of a computer-implemented method for determining the execution performance of the one or more generative AI models, in accordance with an embodiment of the present disclosure; and

FIG. 7 illustrates an exemplary block diagram representation of a server platform for implementation of the disclosed computer-implemented system, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration. ” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises... a“ does not, without more constraints, preclude the existence of other devices, sub-systems, additional sub-modules. Appearances of the phrase ”in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, user/client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

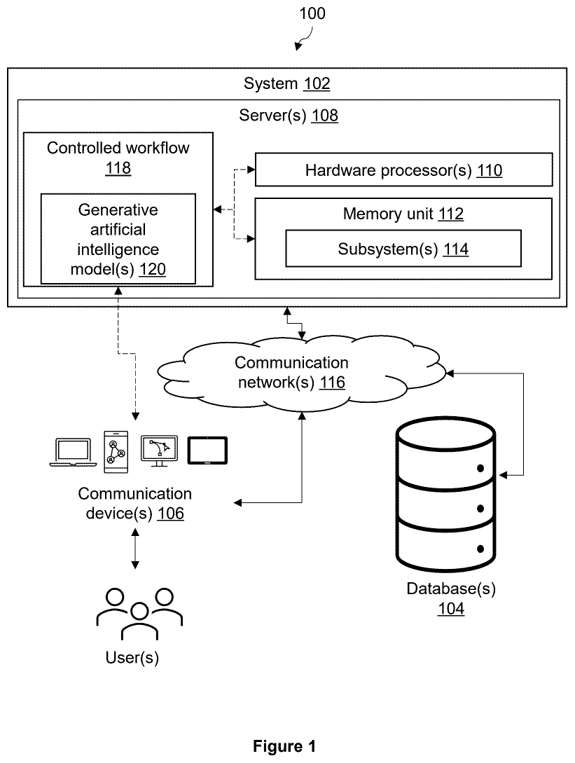

Referring now to the drawings, and more particularly to FIG. 1 through FIG. 7, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 of a computer-implemented system 102 for determining an execution performance of one or more generative artificial intelligence (AI) models 120, in accordance with an embodiment of the present disclosure.

According to an exemplary embodiment of the present disclosure, the network architecture 100 may include the computer-implemented system 102, one or more databases 104, and one or more communication devices 106. The computer-implemented system 102, the one or more databases 104, and the one or more communication devices 106 may be communicatively coupled via one or more communication networks 116, ensuring seamless data transmission, processing, and decision-making. The computer-implemented system 102 acts as the central processing unit within the network architecture 100, responsible for determining the execution performance of the one or more generative AI models 120.

In an exemplary embodiment, the computer-implemented system 102 is configured with a controlled workflow 118 where the one or more generative AI models 120 are wrapped for determining the execution performance of one or more generative AI models 120 in a controlled testing environment. The controlled workflow 118 is a Retrieve-Augment-Generate (RAG) workflow. The RAG workflow allows tracing first output data generated by the one or more generative AI models 120 upon providing input data, ensuring that the first output data may be monitored and traced back to the provided input data and context information.

In an exemplary embodiment, the computer-implemented system 102 comprises one or more servers 108. The one or more servers 108 may comprise a combination of discrete components, an integrated circuit, an application-specific integrated circuit, a field-programmable gate array, a digital signal processor, or other suitable one or more hardware processors 110 and a software. The “software” may comprise one or more objects, agents, threads, lines of code, subroutines, separate software applications, two or more lines of code, or other suitable software structures operating in one or more software applications or the one or more hardware processors 110. The one or more servers 108 comprises the one or more hardware processors 110 and a memory unit 112. The memory unit 112 is operatively connected to the one or more hardware processors 110. The memory unit 112 comprises a set of computer-readable instructions in form of a plurality of subsystems 114, configured to be executed by the one or more hardware processors 110.

In an exemplary embodiment, the one or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in the memory unit 112 operationally coupled with the computer-implemented system 102 for performing tasks such as data processing, input/output processing, and/or any other functions. Any reference to a task in the present disclosure may refer to an operation being or that may be performed on data. The one or more hardware processors 110 is high-performance processors capable of handling large volumes of data and complex computations. The one or more hardware processors 110 may be, but not limited to, at least one of: multi-core central processing units (CPU), graphics processing units (GPUs), and specialized Artificial Intelligence (AI) accelerators that enhance an ability of the computer-implemented system 102 to process real-time data from one or more sources simultaneously.

In an exemplary embodiment, the one or more databases 104 may configured to store, and manage data related to various aspects of the computer-implemented system 102. The one or more databases 104 may store at least one of: the input data provided to the one or more generative AI models 120, the first output data generated by the one or more generative AI models 120, the second output data comprising expected results or ground truth data, context information retrieved from external sources, query data associated with user interactions, pre-trained models including embedding vectors, X-encoder models, and one or more machine learning models for profanity detection, as well as predefined datasets for vulnerability detection and jailbreaking test cases. Additionally, the one or more databases 104 may store performance metrics, including correctness scores, pertinence scores, similarity scores, profanity scores, and vulnerability scores, along with respected threshold scores and configuration settings necessary for generating performance reports. The one or more databases 104 enable the computer-implemented system 102 to dynamically retrieve, analyze, and update the stored data in real-time, facilitating continuous performance evaluation and optimization of the one or more generative AI models 120. The one or more databases 104 may include different types of databases such as, but not limited to, relational databases (e.g., Structured Query Language (SQL) databases), non-Structured Query Language (NoSQL) databases (e.g., MongoDB, Cassandra), time-series databases (e.g., InfluxDB), an OpenSearch database, and object storage systems (e.g., Amazon S3, PostgresDB).

In an exemplary embodiment, the one or more communication devices 106 are configured to provide the one or more generative AI models 120 to the computer-implemented system 102 for determining the execution performance. Additionally, the one or more communication devices 106 are configured to provide the input data, and the second output data by one or more uses to processing by the computer-implemented system 102. The one or more communication devices 106 may be digital devices, computing devices, and/or networks. The one or more communication devices 106 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like.

In an exemplary embodiment, the one or more communication devices 106 may be associated with, but not limited to, one or more service providers, one or more customers, an individual, an administrator, a vendor, a technician, a specialist, an instructor, a supervisor, a team, an entity, an organization, a company, a facility, a bot, any other user, and combination thereof. The entity, the organization, and the facility may include, but not limited to, an e-commerce company, online marketplaces, service providers, retail stores, a merchant organization, a logistics company, warehouses, transportation company, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like.

In an exemplary embodiment, the one or more communication networks 116 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, or a combination of networks. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth, ZigBee, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the computer-implemented system 102 may be implemented by way of a single device or a combination of multiple devices that may be operatively connected or networked together. The computer-implemented system 102 may be implemented in hardware or a suitable combination of hardware and software.

Though few components and the plurality of subsystems 114 are disclosed in FIG. 1, there may be additional components and subsystems which is not shown, such as, but not limited to, ports, routers, repeaters, firewall devices, network devices, the one or more databases 104, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the computer-implemented system 102, and the one or more communication devices 106 connected to the one or more databases 104, one skilled in the art can envision that the computer-implemented system 102, and the one or more communication devices 106 may be connected to several user devices located at various locations and several databases via the one or more communication networks 116.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the computer-implemented system 102 as is unique to the present disclosure or necessary for an understanding of the present disclosure is depicted and described. The remainder of the construction and operation of the computer-implemented system 102 may conform to any of the various current implementations and practices that were known in the art.

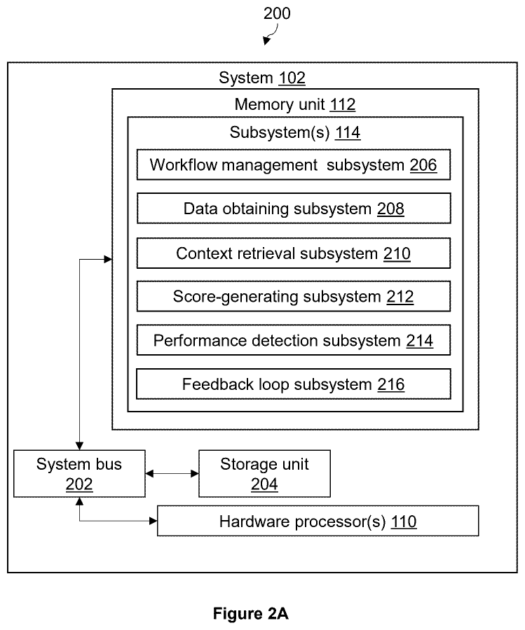

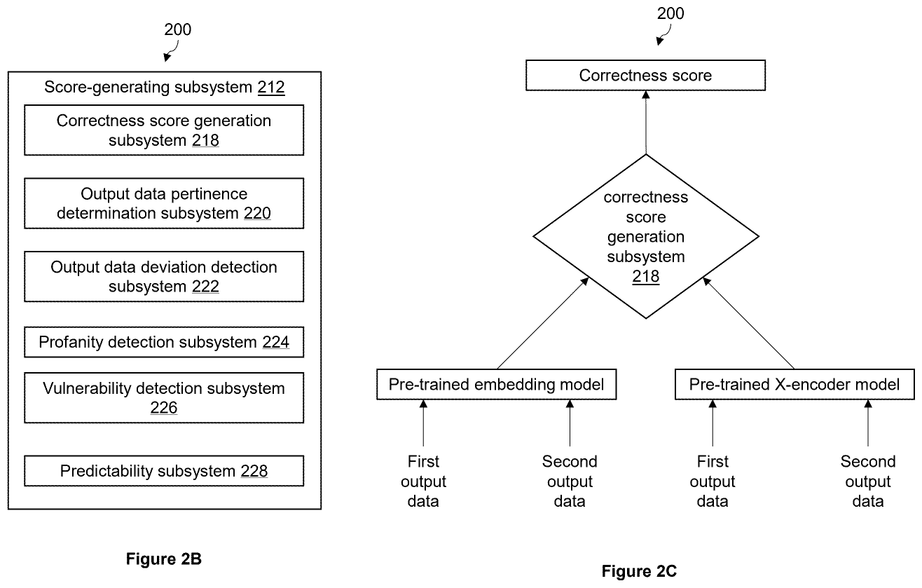

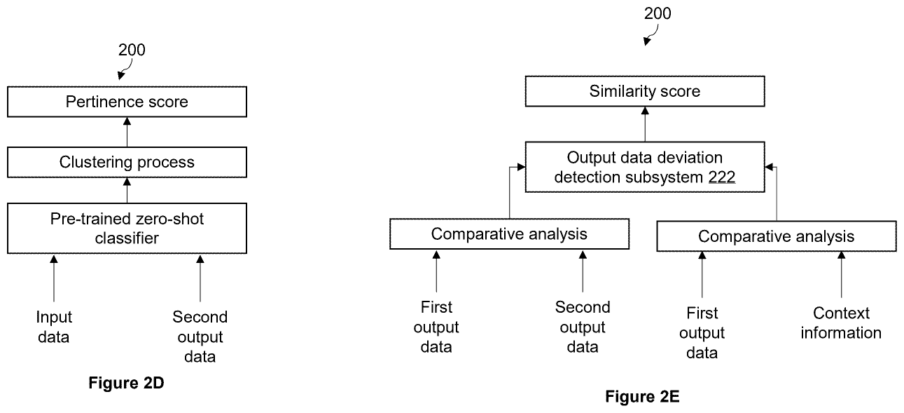

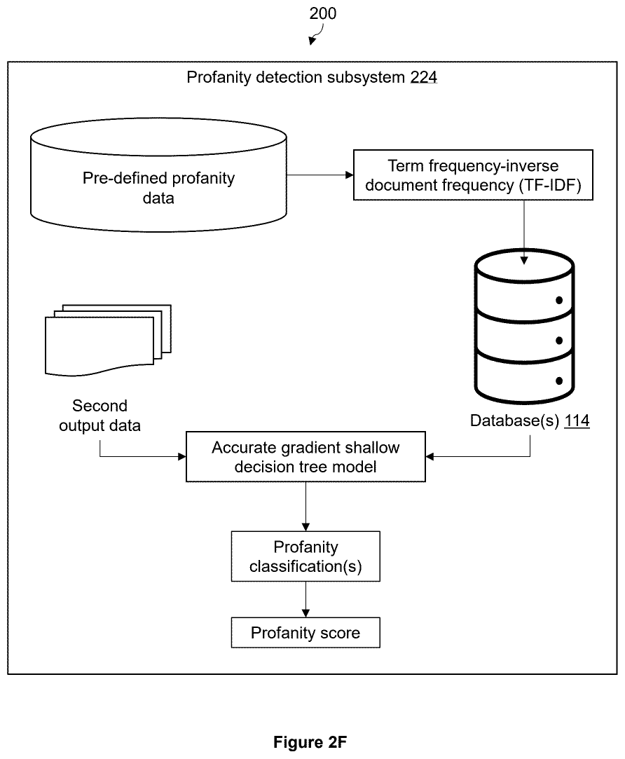

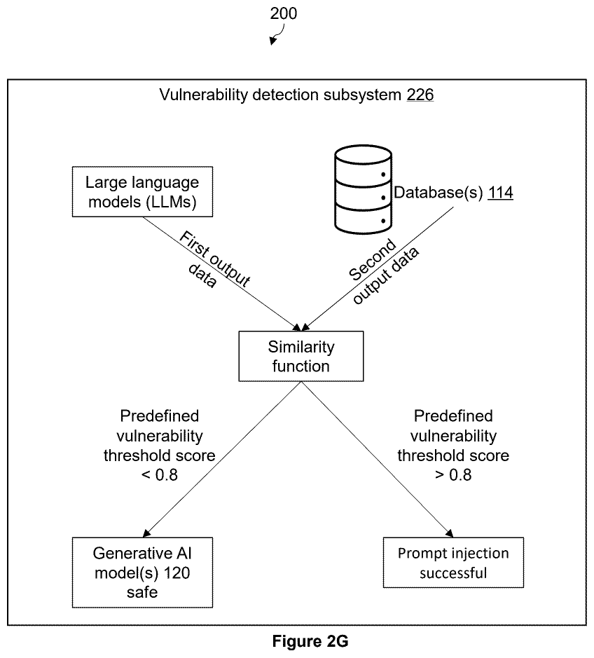

FIG. 2A illustrates an exemplary block diagram 200 of the computer-implemented system 102 as shown in FIG. 1 for determining the execution performance of the one or more generative AI models 120, in accordance with an embodiment of the present disclosure.

FIG. 2B illustrates an exemplary block diagram of a score-generating subsystem 212, in accordance with an embodiment of the present disclosure.

FIG. 2C illustrates an exemplary schematic diagram of a correctness score generation subsystem 218, in accordance with an embodiment of the present disclosure.

FIG. 2D illustrates an exemplary schematic diagram of an output data pertinence determination subsystem 220, in accordance with an embodiment of the present disclosure.

FIG. 2E illustrates an exemplary schematic diagram of an output data deviation detection subsystem 222, in accordance with an embodiment of the present disclosure.

FIG. 2F illustrates an exemplary schematic diagram of a profanity detection subsystem 224, in accordance with an embodiment of the present disclosure.

FIG. 2G illustrates an exemplary schematic diagram of a vulnerability detection subsystem 226, in accordance with an embodiment of the present disclosure.

In an exemplary embodiment, the computer-implemented system 102 (hereinafter referred to as the system 102) comprises the one or more servers 108, the memory unit 112, and a storage unit 204. The one or more hardware processors 110, the memory unit 112, and the storage unit 204 are communicatively coupled through a system bus 202 or any similar mechanism. The system bus 202 functions as the central conduit for data transfer and communication between the one or more hardware processors 110, the memory unit 112, and the storage unit 204. The system bus 202 facilitates the efficient exchange of information and instructions, enabling the coordinated operation of the system 102. The system bus 202 may be implemented using various technologies, including but not limited to, parallel buses, serial buses, or high-speed data transfer interfaces such as, but not limited to, at least one of a: universal serial bus (USB), peripheral component interconnect express (PCIe), and similar standards.

In an exemplary embodiment, the memory unit 112 is operatively connected to the one or more hardware processors 110. The memory unit 112 comprises the plurality of subsystems 114 in the form of programmable instructions executable by the one or more hardware processors 110. The plurality of subsystems 114 comprises a workflow management subsystem 206, a data obtaining subsystem 208, a context retrieval subsystem 210, a score-generating subsystem 212, a performance detection subsystem 214, and a feedback loop subsystem 216. The one or more hardware processors 110 associated within the one or more servers 108, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory unit 112 may be the non-transitory volatile memory and the non-volatile memory. The memory unit 112 may be coupled to communicate with the one or more hardware processors 110, such as being a computer-readable storage medium. The one or more hardware processors 110 may execute machine-readable instructions and/or source code stored in the memory unit 112. A variety of machine-readable instructions may be stored in and accessed from the memory unit 112. The memory unit 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 112 includes the plurality of subsystems 114 stored in the form of machine-readable instructions on any of the above-mentioned storage media and may be in communication with and executed by the one or more hardware processors 110.

The storage unit 204 may be a cloud storage or the one or more databases 104 such as those shown in FIG. 1. The storage unit 204 may store, but not limited to, recommended course of action sequences dynamically generated by the system 102. These action sequences are based on at least one of: performance metrics derived from the one or more generative AI models 120, including correctness scores, pertinence scores, similarity scores, profanity scores, and vulnerability scores; the contextual information retrieved from external data sources; the input data such as text, numerical data, images, audio, or video; user feedback or preferences provided during interaction with the system 102; and historical data trends from previous evaluations. The dynamically generated action sequences may be used to optimize the evaluation of the system 102, improve response accuracy, enhance security protocols, or adjust the behavior of the system 102 to align with updated requirements or contexts. Additionally, the storage unit 204 may retain previous action sequences for comparison and future reference, enabling continuous refinement of the system 102 over time. The storage unit 204 may be any kind of database such as, but not limited to, relational databases, dedicated databases, dynamic databases, monetized databases, scalable databases, cloud databases, distributed databases, any other databases, and a combination thereof.

In an exemplary embodiment, the workflow management subsystem 206 is configured to operate the one or more generative AI models 120 within the controlled workflow 118 by providing input data to the one or more generative AI models 120 for obtaining the first output data. The controlled workflow 118 is a Retrieval Augmented Generation (RAG) workflow, which is configured to enhance an ability of the one or more generative AI models 120 to generate accurate and contextually relevant responses by retrieving the relevant contextual information from one or more databases 104. The controlled workflow 118 is configured to retrieve the context information from the input data during the execution of the one or more generative AI models 120. The retrieved context information is dynamically extracted from at least one of: the input data and the associated one or more databases 104.

Additionally, the controlled workflow 118 is configured to assign one or more ranks to the retrieved context information. The ranking process is essential for determining the relative importance and relevance of the context information retrieved during execution of the one or more generative AI models 120. The ranking is performed based on predefined parameters, such as similarity scores, relevance to the input data, or other contextual metrics defined by the system 102. This ranking allows the system 102 to prioritize the optimal context information, determining that the first output data generated by the one or more generative AI models 120 is aligned with the provided input data.

In an exemplary embodiment, the data obtaining subsystem 208 is configured to obtain at least one of: the input data, the first output data, and second output data from at least one of: the one or more generative AI models 120, the one or more users, and historic system data. The input data comprises, but not limited to, one or more of: text data, numerical data, images, audio data, video data, and the like, provided to the one or more generative AI models for processing. The input data is fundamental to the functioning of the one or more generative AI models 120, as the input data serves as the basis for generating the first output data, which is the result of processing the input by the one or more generative AI models 120. The first output data comprises results generated by the one or more generative AI models in response to the input data. The first output data includes, but not limited to, one or more at least one of: predicted text, classified categories, generated images, audio transcriptions, predicted numerical values, and the like. The first output data is the primary result produced by the one or more generative AI models 120 and reflects the processing capability of the one or more generative AI models 120 for the provided input data. The second output data comprises, but not limited to, at least one of: a set of expected results and ground truth data. The second output data comprises at least one of: predetermined data and derived data from the historical system data, which is used to evaluate the first output data provided by the one or more generative AI models 120. The second output data serves as a reference against which the correctness (faithfulness), the output data pertinence (output relevance), and the output data deviation (hallucination), and profanity (Toxicity) of the first output data may be measured. The expected results and the ground truth data may be pre-established based on prior knowledge or generated dynamically from historical data stored in the system 102. This comparison between the first output data and the second output data allows the system 102 to determine how efficiently the one or more generative AI models 120 performed in processing the provided input data, identifying any deviations, inaccuracies, or inconsistencies in the first output data generated.

In an exemplary embodiment, the context retrieval subsystem 210 is configured to retrieve the context information from at least one of: the input data and the second output data stored in the one or more databases 104, based on the one or more queries provided to the one or more generative AI models 120. The context retrieval subsystem 210 is configured to ensure that the one or more generative AI models 120 are supplied with relevant contextual information during the execution of the one or more queries, allowing the one or more generative AI models to generate more accurate, relevant, and contextually aware outputs. The context retrieval subsystem 210 operates by analyzing and extracting necessary contextual data from both the input data provided by the one or more users. The context retrieval subsystem 210 is configured to store the context information, the input data, the second output data, and the one or more queries in a form of one or more vector embeddings. The context retrieval subsystem 210 is configured with a cosine similarity model. The cosine similarity model is configured to retrieve the context information based on determining a cosine angle between the one or more vector embeddings associated with the one or more queries and the one or more vector embeddings associated with the input data. The cosine angle provides a measure of how similar the first output data compared to the second output data. A smaller angle between the one or more vector embeddings associated with the input data indicates higher similarity of the context information, whereas a larger angle signifies lower similarity of the context information.

In an exemplary embodiment, the score-generating subsystem 212 (as depicted in FIG. 2B) comprises the correctness score generation subsystem 218, the output data pertinence determination subsystem 220, the output data deviation detection subsystem 222, the profanity detection subsystem 224, the vulnerability detection subsystem 226, and a predictability subsystem 228.

In an exemplary embodiment, the correctness score generation subsystem 218 (as depicted in FIG. 2C) is configured to determine the correctness of the one or more generative AI models 120 by performing a comparative analysis between the first output data and the second output data using at least one of: a pre-trained embedding model and a pre-trained X-encoder model for generating the correctness score. The comparative analysis evaluates how closely the first output data, generated by the one or more generative AI models 120 in response to the provided input data, aligns with the second output data, which typically comprises expected results or ground truth data

The pre-trained embedding model uses the cosine similarity model to identify a contextual relationship between the first output data and the second output data. Specifically, the pre-trained embedding model transforms both the first output data and the second output data into the one or more vector embeddings and calculates the cosine similarity between the one or more vector embeddings associated with the first output data and the one or more vector embeddings associated with the second output data. This results in a semantic similarity score, which measures how contextually aligned the first output data and the second output data are. The cosine similarity is computed by evaluating the cosine angle between the vector embeddings, where a smaller angle indicates a higher degree of similarity, and a larger angle reflects greater divergence between the two data sets.

The pre-trained X-encoder model is configured to identify an intricate relationship between the first output data and the second output data that may not be captured by the pre-trained embedding model alone. Unlike the pre-trained embedding model, which primarily focuses on broader contextual relationships, the pre-trained embedding model X-encoder model delves deeper into the specific nuances and detailed correspondences between the first output data and the second output data. The pre-trained X-encoder model analyzes both the first output data and the second output data in a more granular fashion to generate an X-encoder score, which reflects how well the detailed patterns and semantics of the first output data correspond to the second output data (expected results).

To ensure a balanced evaluation, the correctness score generation subsystem 218 is further configured to regulate the semantic similarity score and the X-encoder score using a weighted combination. The weighting of these scores is based on a similarity threshold determined by a semantic similarity function. This function determines whether the broader contextual alignment (as measured by the embedding model) or the intricate, detailed relationship (as measured by the X-encoder model) should be given more importance in generating the final correctness score. If the correctness score is one of: within a predefined correctness threshold score and equal to the predefined correctness threshold score, the system 102 determines that the first output data is apposite to the provided input data. This means that the first output data generated by the one or more generative AI models 120 is deemed accurate and consistent with the second output data, as the similarity between the first output data and the second output data falls within acceptable parameters. However, if the correctness score exceeds the predefined correctness threshold score, the system 102 determines that the first output data is inapt with the provided input data, indicating that the first output data generated by the one or more generative AI models 120 deviates significantly from the second output data, possibly due to errors, lack of context alignment, or failure to capture intricate details.

For instance, the correctness score typically falls within a range from 0 to 1. Where ‘0’ indicates no similarity or correctness between the first output data and the second output data. Wherein ‘1’ indicates complete similarity or correctness, meaning the first output data perfectly matches the second output data. This score reflects how closely the first output data generated by the one or more generative AI models 120 aligns with the second output data. In an exemplary embodiment, the predefined correctness threshold score may generally fall within a pre-defined range that determines the acceptable level of correctness. The predefined correctness threshold score is defined based on the desired accuracy or tolerance for the specific use case. A typical predefined correctness threshold score might range between 0.7 and 0.9, where: a) the correctness score equal to or above 0.7 indicates that the generated output data by the one or more generative AI models 120 is acceptable or correct in most cases (contextually apposite), and b) The correctness score below the 0.7 indicates that the generated output data by the one or more generative AI models 120 may be incorrect or misaligned with the expected results (contextually inapt).

In an exemplary embodiment, the output data pertinence determination subsystem 220 (as depicted in FIG. 2D) is configured to determine a pertinence of the first output data in relation to the provided input data to the one or more generative AI models 120 using at least one of: a pre-trained zero-shot classifier and a clustering process, to generate the pertinence score. The pertinence score is an essential measure of how well the generated first output data aligns with the provided input data in terms of relevance and contextual consistency.

The output data pertinence determination subsystem 220 functions by mapping the one or more vector embeddings associated with the input data and the one or more vector embeddings associated with the first output data into a clustered space. In this clustered space, the distance between the vector embeddings of the input data and the first output data is calculated. The smaller the distance between the one or more vector embeddings of the input data and the first output data in this clustered space, the higher the relevance and pertinence of the first output data to the input data. The pertinence score is then generated based on this distance, reflecting how closely related the first output data is to the original input data in terms of meaning and context.

The pre-trained zero-shot classifier is based on a Natural Language Inference (NLI) model trained on the Multi-Genre Natural Language Inference (MultiNLI) dataset, which contains 433,000 sentence pairs. This dataset allows the NLI model to learn a wide range of semantic relationships between pairs of texts across multiple domains. The NLI model used is a powerful transformer architecture based on BART (Bidirectional and Auto-Regressive Transformers), which excels at understanding the relevance of one sentence to another. The NLI model is capable of zero-shot classification, allowing it to evaluate the pertinence of first output data without requiring additional training on specific datasets.

In an exemplary embodiment, the NLI model classifies the semantic relationship between the input data and the first output data into three categories: a) entailment, b) contradiction, and c) neutral. In entailment the input data and the first output data are highly relevant and logically consistent, whereas the contradiction refers that the input data and the first output data are not relevant and contradict each other. The neutral refers that the input data and the first output data are neither relevant nor contradictory, indicating a neutral relationship. The pertinence score is derived by taking the probability output for the entailment class. This probability represents how strongly the first output data is semantically entailed by (or relevant to) the provided input data. The higher the probability of entailment, the more pertinent the first output data is to the input data. Further, the output data pertinence determination subsystem 220 use a hypothesis template to convert the input data into a hypothesis and treats the output as the premise. For instance, the premise: “My name is XYZZ” (from the first output data). The one or more users label as: “What is your name?” (from the input data), the hypothesis template: the input is transformed into the hypothesis, such as “This text is consistent with the statement: What is your name?”. The NLI model then compares the premise (output) with the hypothesis (input) and generates probabilities for each of the three classes: entailment, contradiction, and neutral. In this system 102, only the entailment score is considered to generate the pertinence score.

If the pertinence score is one of: within a predefined pertinence threshold score and equal to the predefined pertinence threshold score, the system 102 determines that the first output data is at least one of: optimal correlated (entailment) and neutral, with the provided input data. If the pertinence score exceeds the predefined pertinence threshold score, the system 102 determines that the first output data is in contradiction to the provided input data. For instance, the pertinence score typically falls within a range of 0 to 1, where: a) ‘0’ indicates no pertinence, meaning the first output data is entirely unrelated to the provided input data, and b) 1 indicates complete pertinence, meaning the first output data is optimally correlated with the provided input data. The predefined pertinence threshold score determines the level at which the output data is considered contextually relevant. This threshold is typically within the range of 0.7, where: a) the pertinence score within 0.7 signifies that the first output data is contextually relevant or equal to 0.7 signifies that the first output data is neutral with respect to the input data, and b) the pertinence score exceeds 0.7 indicates that the first output data is contextually misaligned or contradicts the input data.

In an exemplary embodiment, the output data deviation detection subsystem 222 (as depicted in FIG. 2E) is configured to identify a deviation (Hallucination) of the first output data generated by the one or more generative AI models 120 from the provided input data. The deviation is determined based on at least of: a) a comparative analysis between the first output data and the second output data, and b) a comparative analysis between the first output data and the context information, for generating a similarity score. This output data deviation detection subsystem 222 is inverse to the correctness score generation subsystem 218, i.e. inverse to the correctness of the first output data.

The output data deviation detection subsystem 222 is configured to identify a deviation of the first output data based on comparing the similarity score with a predefined similarity threshold score. If the similarity score is one of: within the predefined similarity threshold score and equal to the predefined similarity threshold score, the system 102 determines that the first output data is in line with the input data. If the similarity score exceeds the predefined similarity threshold score, the system 102 determines that the first output data is deviated from the provided input data.

For instance, if the similarity score typically falls within a range from 0 to 1, where: a) ‘0’ indicates no similarity between the first output data and at least one of: the second output data and the context information, and b) ‘1’ indicates complete similarity, meaning the first output data is entirely aligned with at least one of: the second output data and the context information. The predefined similarity threshold score is a configurable value that determines the acceptable level of similarity required for the first output data generated by the one or more generative AI models to be considered aligned with the input data. The predefined similarity threshold score typically falls within a range of 0.5 to 0.7, where: a) the similarity score within or equal to 0.7 indicates that the first output data is in line with the input data and context, b) the similarity score exceeds 0.7 signifies that the first output data is deviated from the provided input data or the context information. The threshold may be adjusted based on the specific use case, with more critical applications (such as medical diagnosis or financial modeling) requiring higher thresholds to ensure accuracy and consistency.

In an exemplary embodiment, the profanity detection subsystem 224 (as depicted in FIG. 2F) is configured to analyze the first output data to identify profanity data in the first output data using one or more machine learning models trained on pre-defined profanity data, which indicates the extent to which the one or more generative AI models 120 generated first output contains inappropriate or offensive language. The one or more machine learning models comprise an accurate gradient shallow decision tree model. The accurate gradient shallow decision tree model is configured to identify the profanity data in the first output data based on the one or more profanity data vectors.

The pre-defined profanity data is pre-processed to convert into one or more profanity data vectors. This pre-processing step involves converting the collected profanity data (which may consist of terms, phrases, or other linguistic structures commonly recognized as profane or offensive) into vector representations. The one or more profanity data vectors enable the one or more machine learning models to efficiently analyze and compare the first output data at a mathematical level, ensuring accurate classification of any profanity present.

The profanity detection subsystem 224 is configured to assign each profanity data vector of the one or more profanity data vectors in relation to one or more profanity classifications. The assigning mechanism ensures that certain types of profanity or offensive content are assigned higher importance based on their severity or frequency of occurrence. For example, highly offensive terms may receive higher weights, thereby increasing their impact on the overall profanity score.

To identify profanity in the first output data, the profanity detection subsystem 224 is further configured to classify the first output data by comparing the one or more vector embeddings associated with the first output data against the one or more profanity data vectors. This comparison is done through a similarity check, which evaluates how closely the first output data matches the one or more profanity data vectors. The system 102 utilizes these comparisons to determine the degree of profanity present in the first output data. Based on this comparison, the profanity detection subsystem 224 generates the profanity score. The profanity score is determined by evaluating the number of vector embeddings in the first output data that match with the one or more profanity data vectors associated with one or more profanity classifications. The profanity score reflects the intensity and occurrence of profane content within the first output data.

The pre-defined profanity dataset, which is structured with columns that include comment text (toxic or non-toxic sentences) and labels for a plurality of profanity classes. The plurality of profanity classes may include, but not limited to, toxic, severe toxic, obscene, threat, insult, and identity hate. The plurality of profanity classes provides the foundational training data for the one or more machine learning models that detect and classify profanity or inappropriate content in the first output data. The profanity detection subsystem 224 uses an XGBoost machine learning (ML) model, which is trained on the pre-defined profanity dataset. The training process includes several key steps: a) The pre-defined profanity dataset undergoes necessary preprocessing, including stop word removal, conversion to lowercase, punctuation removal, tokenization (like Classify Token ([CLS]) and Separate token ([SEP])), and lemmatization. These steps clean the pre-defined profanity dataset and ensure that the pre-defined profanity dataset is in a suitable format for vectorization and training, b) The dataset is split into the comment text and the plurality of profanity classes, and both parts are converted into vectors using a TF-IDF (Term Frequency-Inverse Document Frequency) vectorizer. The TF-IDF vectorization transforms the textual data into numerical form, enabling the one or more machine learning models to analyze and learn patterns from the pre-defined profanity dataset, c) The XGBoost ML model is trained on the vectorized data to learn how to classify the first output data into the one or more profanity classifications. Each profanity class of the plurality of profanity classes is trained individually on the pre-defined profanity dataset to capture detailed information related to each type of profanity. This process ensures that the one or more machine learning models able to identify a wide range of profanity content across different severity level.

If the profanity score is one of: within a predefined profanity threshold score and equal to the predefined profanity threshold score, the system 102 determines that the first output data is tolerable. If the profanity score exceeds the predefined profanity threshold score, the system 102 determines that the first output data contains exceptionable profanity data and triggers for at least one of: flagging and filtering, the profanity data. For instance, the profanity score typically falls within a range of 0 to 1, where: a) ‘0’ indicates no profanity detected in the first output data, b) ‘1’ indicates maximum profanity, meaning the first output data contains a significant amount of offensive or inappropriate content. The predefined profanity threshold score is typically set between 0.3 and 0.6, depending on the severity of the application and tolerance for offensive content. The range may be configured as follows: a) the profanity score within or equal to 0.3 or 0.6 indicates that the profanity level is tolerable, b) the profanity score exceeding 0.6 indicates that the first output data contains exceptionable profanity, necessitating actions such as flagging or filtering. The specific threshold may be adjusted based on the system's deployment environment, where certain applications may require stricter tolerance for profanity (e.g., educational or professional applications).

In an exemplary embodiment, the vulnerability detection subsystem 226 (as depicted in FIG. 2G) is configured to determine a susceptibility of the first output data based on comparing the first output data with one or more jailbreaking test cases for generating the vulnerability score. The vulnerability detection subsystem 226 is configured to evaluate how robust the one or more generative AI models 120 are when exposed to jailbreaking or prompt injection attacks, where malicious prompts attempt to override the intended behavior of the one or more generative AI models 120.

To accomplish this, the system 102 utilizes the one or more databases 104 of jailbreaking test cases, which have been collected during red teaming efforts conducted on similar large language models (LLMs). The jailbreaking test cases include a plurality of predefined attack prompts and their corresponding expected responses, based on how the LLMs behaved during prior testing under malicious scenarios. The vulnerability detection subsystem 226 compares the first output data (i.e., the actual response generated by the one or more generative AI models 120 in the real-time evaluation) to these predefined attack cases. The vulnerability detection subsystem 226 applies the similarity function to assess how closely the first output data matches the expected responses in the jailbreaking test cases. Specifically, it uses the predefined vulnerability threshold score of 0.8, meaning that if the similarity between the first output data and the second output data is greater than or equal to 0.8, it indicates a strong resemblance to what would be expected if the model had succumbed to a successful prompt injection attack. This similarity metric helps the system determine whether the AI model has successfully resisted or is vulnerable to the attack.

In an exemplary embodiment, if the vulnerability score is one of: within a predefined vulnerability threshold score and equal to the predefined vulnerability threshold score, the system 102 determines that the one or more generative AI models 120 are benign. If the vulnerability score exceeds the predefined vulnerability threshold score, the system 102 determines that the one or more generative AI models 120 are malignant. For instance, the vulnerability score typically falls within a range of 0 to 1, where: ‘0’ indicates no vulnerability, meaning the first output data is entirely resistant to the prompt injection attack, whereas ‘1’ indicates maximum vulnerability, meaning the first output data is highly susceptible to the attack and aligns closely with the expected malicious response. The predefined vulnerability threshold score may be 0.8. The vulnerability score within or equal to 0.8 suggests that the one or more generative AI models 120 are benign and resistant to jailbreaking attempts. The vulnerability score exceeds 0.8 suggests that the one or more generative AI models 120 are malignant and vulnerable, having produced a response closely resembling the malicious prompt's expected outcome. The predefined vulnerability threshold score is configurable depending on the specific security requirements, with stricter thresholds being applied in environments where the one or more generative AI models 120 are deployed in sensitive or high-stakes applications (e.g., financial, healthcare, and legal contexts).

In an exemplary embodiment, the predictability subsystem 228 is configured to determine a probability of each consecutive action (word) of one or more actions to execute in the first output data generated by the one or more generative AI models 120. The predictability subsystem 228 achieves this by utilizing an n-gram language model to evaluate the execution performance of the one or more generative AI models 120. The goal of the predictability subsystem 228 is to assess how well the one or more generative AI models may predict the next consecutive action, such as the next word in a sequence, based on previous actions (words).

The n-gram language model is a statistical language model that is trained to predict the probability of a given word or action based on the preceding n−1 words. In an exemplary embodiment, the predictability subsystem 228 is configured to train the n-gram language model on the input data provided to the one or more generative AI models 120. This training process involves tokenizing the input data into sequences of n-grams and calculating the frequency of each n-gram sequence to build a set of instructions for language usage. The trained n-gram model is then applied to the first output data generated by the AI model to determine the probability of each consecutive action (such as word or phrase) occurring in that sequence.

To evaluate the execution performance of the one or more generative AI models 120, the predictability subsystem 228 uses the trained n-gram language model to generate a perplexity score. The perplexity score is a common metric used to evaluate the performance of the one or more generative AI models 120, and the predictability subsystem 228 measures how well the one or more generative AI models 120 predicts the sequence of words in the first output data. A lower perplexity score indicates that the one or more generative AI models 120 has a high probability of accurately predicting each consecutive action in the sequence, whereas a higher perplexity score indicates that the one or more generative AI models 120 is less certain in its predictions.

Once the perplexity score is generated, the predictability subsystem 228 is configured to normalize the perplexity score to a defined perplexity range. Normalization allows the perplexity score to be interpreted consistently across different datasets and models, ensuring that the perplexity score is comparable and meaningful in the context of the execution performance of the one or more generative AI models 120.

If the perplexity score is one of: within a predefined perplexity threshold score of the defined perplexity range and equal to the predefined perplexity threshold score of the defined perplexity range, the system 102 determines that the probability of predicting each consecutive action of one or more actions is superior. If the perplexity score exceeds the predefined perplexity threshold score of the defined perplexity range, the system 102 determines the probability of predicting each consecutive action of one or more actions is inferior. For instance, the perplexity score typically ranges from 0 to 1, where: ‘1’ indicates that the one or more generative AI models 120 is highly confident in predicting the next action in the sequence, reflecting strong predictability, and ‘0’ indicates greater uncertainty in the one or more generative AI models 120 predictions, reflecting weaker predictability. The predefined perplexity threshold score is typically 0.5, where: the perplexity score within or equal to 0.5 indicates that the ability of the one or more generative AI models 120 are configured to predict consecutive actions is superior, meaning the predictions are accurate and consistent, whereas the predefined perplexity threshold score is exceeding 0.5 indicates that the ability of the one or more generative AI models 120 to predict consecutive actions is inferior, indicating higher uncertainty and lower accuracy in the predictions. The exact predefined perplexity threshold score may vary depending on the complexity of the dataset and the required performance level for the specific one or more generative AI models 120.

In an exemplary embodiment, the performance detection subsystem 214 is configured to execute a comparative analysis between at least one of: the correctness score, the pertinence score, the similarity score, the profanity score, the vulnerability score, and the perplexity score against respective threshold scores to generate the performance report for determining execution performance of the one or more generative AI models 120. The threshold scores comprise at least one of: the predefined correctness threshold score, the predefined pertinence threshold score, the predefined similarity threshold score, the predefined profanity threshold score, the predefined vulnerability threshold score, and the predefined perplexity threshold score. The performance detection subsystem 214 is configured to generate the performance report in form at least one of: radar charts, bar charts, line charts, pie charts; scatter plots, and bubble charts. The generated performance report comprises one or more actionable recommendations for optimizing the performance of the one or more generative AI models based on identified at least one of: the correctness score, the pertinence score, the similarity score, the profanity score, the vulnerability score, and the perplexity score.

The recommendations are derived from the insights gained during the comparative analysis of the various performance metrics. For instance, if the correctness score is lower than the predefined correctness threshold score, the performance report may suggest areas where the training data of the one or more generative AI models 120 need adjustment to improve accuracy. Similarly, if the vulnerability score exceeds the predefined vulnerability threshold score, the system 102 may recommend reinforcing the security of the one or more generative AI models 120 to better resist potential attacks.

In an exemplary embodiment, the feedback loop subsystem 216 is configured to continuously re-evaluate the one or more generative AI models 120 based on real-time data. The re-evaluation is performed dynamically, using at least one of: the input data, AI model configurations, and evaluation results, for generating real-time performance reports. The AI model configurations refer to the internal settings or parameters of the one or more generative AI models 120, which may include hyperparameters such as learning rate, AI model architecture, layer configuration, or any other adjustable parameter that may affect the AI model's performance. The feedback loop subsystem 216 continuously monitors the AI configurations to evaluate how changes or updates in the one or more generative AI models 120 architecture impact its overall effectiveness. The evaluation results are the performance scores generated during the one or more AI model's 120 execution. The feedback loop subsystem 216 takes into account the metrics such as correctness score, pertinence score, similarity score, profanity score, vulnerability score, and perplexity score, which reflect the one or more AI model's current performance. By analyzing these evaluation results in real-time, the feedback loop subsystem 216 may identify areas where the one or more generative AI models 120 is excelling or underperforming. The feedback loop subsystem 216 operates in a continuous loop, meaning it constantly monitors the aforementioned data sources to ensure that the one or more generative AI models 120 are performing optimally. This real-time feedback mechanism allows the system 102 to adapt and adjust the one or more generative AI models 120 on-the-fly, enabling improvements without requiring manual intervention after every evaluation cycle.

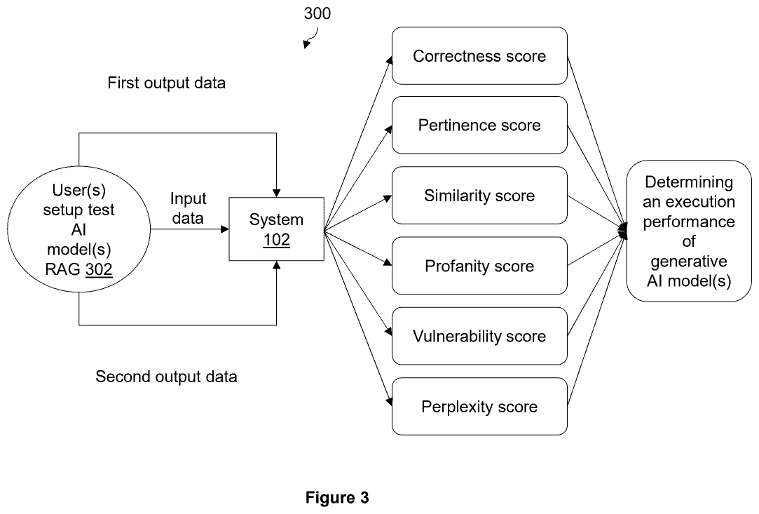

FIG. 3 illustrates an exemplary user/client workflow architecture 300, in accordance with an embodiment of the present disclosure.

In an exemplary embodiment, the one or more users/clients 302 have their own RAG setup (or any other controlled workflow 118), with this RAG setup the one or more users 302 provides only the input data, the first output data and the second output data to system 102 from which the one or more generative AI models 120 is evaluated on various metrics and provide them a final performance report of their tested one or more generative AI models 120.

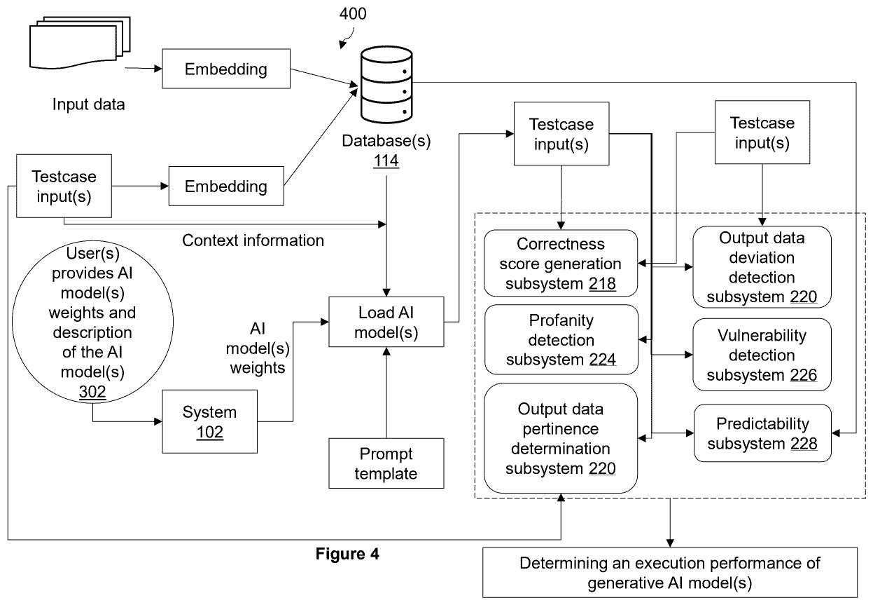

FIG. 4 illustrates an exemplary user/client and the computer-implemented system setup workflow architecture 400, in accordance with an embodiment of the present disclosure.

In an exemplary embodiment, the one or more users 302 inputs the one or more AI model weights along with a description of the one or more generative AI models 120 into the system 102. The system 102 then loads the one or more AI model weights and tests the loaded one or more generative AI models within the RAG workflow (controlled workflow 118) and based on the description of the one or more generative AI models 120, the relevant input data are loaded for testing the one or more generative AI models 120, finally the one or more generative AI models 120 are tested on various metrics and the final performance report is generated to the one or more users 302.

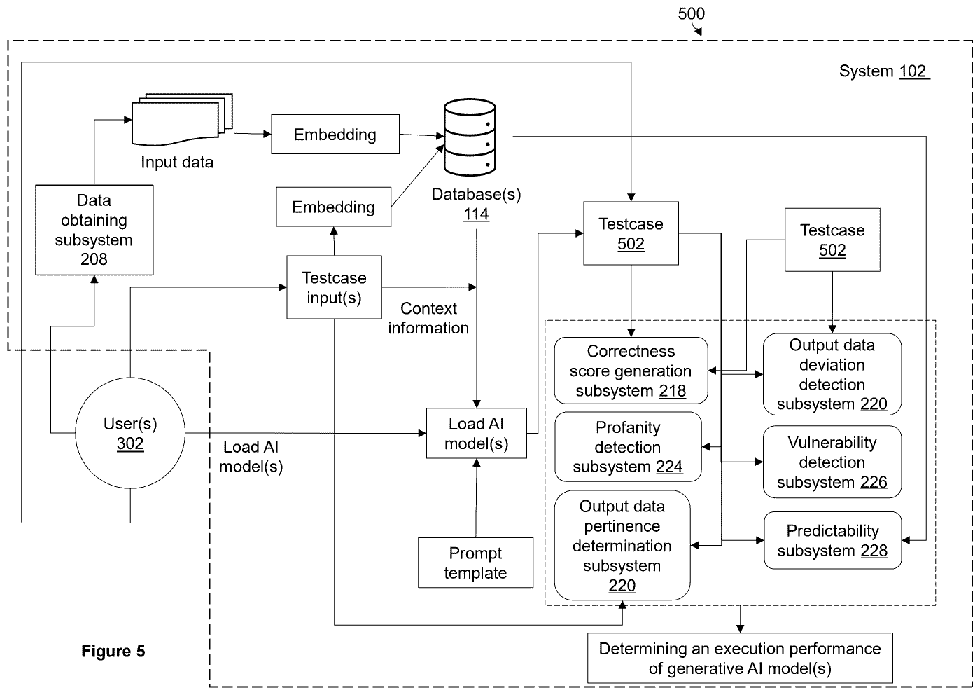

FIG. 5 illustrates an exemplary workflow architecture depicting the computer-implemented system as a website 500, in accordance with an embodiment of the present disclosure.

In an exemplary embodiment, the one or more users 302 opens the website 500 where the system 102 is operational. The website 500 is configured to prompt an option to upload their one or more generative AI models 120 and the relevant input data and the second output data. Based on the provided input data, the one or more generative AI models 120 are tested on a plurality of test cases 502 provided by the one or more users containing pre-defined input data and the second output data, based on the input data and the second output data from the test case along with first output from the tested one or more generative AI models 120, the one or more generative AI models 120 are evaluated on various metrics and the final performance report is sent to the one or more communication devices 106 associated with the one or more users.

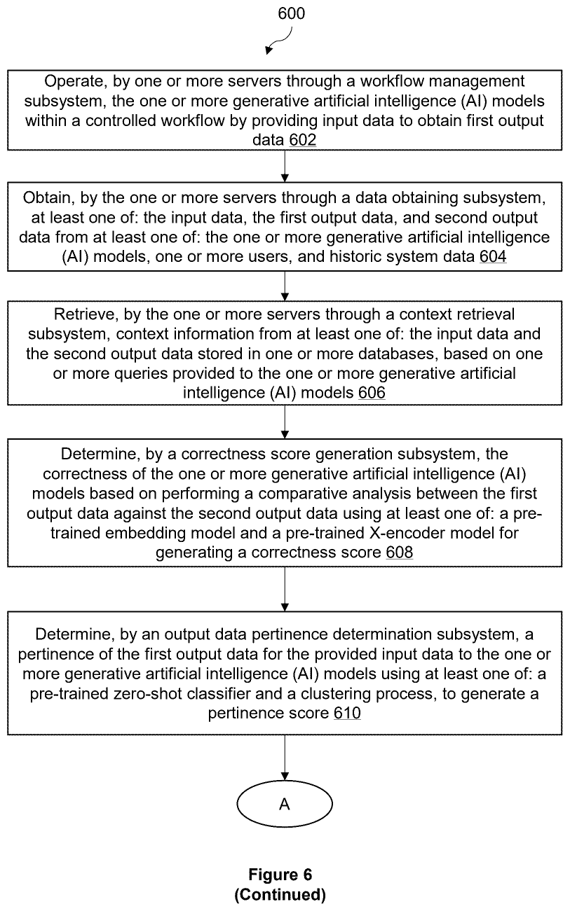

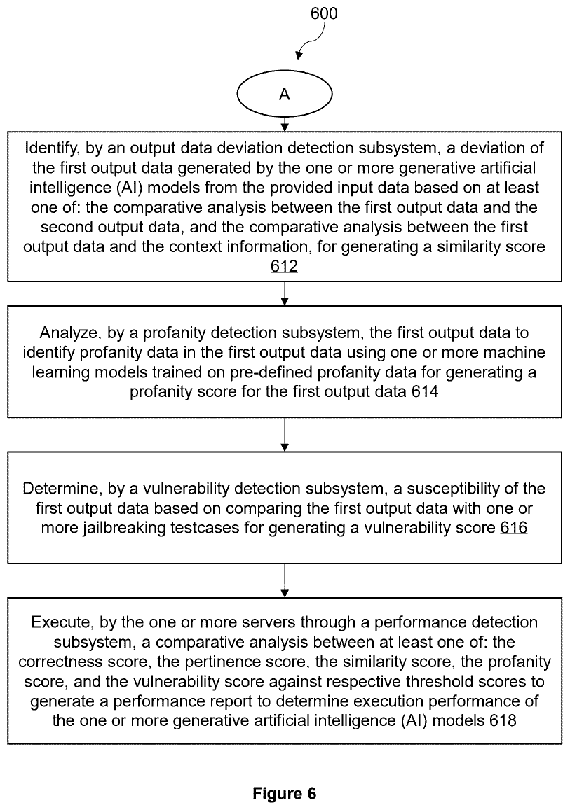

FIG. 6 illustrates an exemplary flow chart of a computer-implemented method 600 for determining the execution performance of the one or more generative AI models 120, in accordance with an embodiment of the present disclosure.

According to another exemplary embodiment of the present disclosure, the computer-implemented method 600 for determining the execution performance of the one or more generative AI models 120 is disclosed. At step 602, the computer-implemented method 600 includes operating, by the one or more servers through the workflow management subsystem, the one or more generative AI models within the controlled workflow by providing the input data to obtain the first output data. At step 604, the implemented method 600 includes obtaining, by the one or more servers through the data obtaining subsystem, at least one of: the input data, the first output data, and the second output data from at least one of: the one or more generative AI models, the one or more users, and the historic system data.

At step 606, the computer-implemented method 600 includes retrieving, by the one or more servers through the context retrieval subsystem, the context information from at least one of: the input data and the second output data stored in the one or more databases, based on the one or more queries provided to the one or more generative AI models. At step 608, the computer-implemented method 600 includes determining, by the correctness score generation subsystem, the correctness of the one or more generative AI models based on performing the comparative analysis between the first output data against the second output data using at least one of: the pre-trained embedding model and the pre-trained X-encoder model for generating the correctness score.

At step 610, the computer-implemented method 600 includes determining, by the output data pertinence determination subsystem, the pertinence of the first output data for the provided input data to the one or more generative AI models using at least one of: the pre-trained zero-shot classifier and a clustering process, to generate the pertinence score. At step 612, the computer-implemented method 600 includes identifying, by the output data deviation detection subsystem, the deviation of the first output data generated by the one or more generative AI models from the provided input data based on at least one of: the comparative analysis between the first output data and the second output data; and the comparative analysis between the first output data and the context information, for generating the similarity score.

At step 614, the computer-implemented method 600 includes analyzing, by the profanity detection subsystem, the first output data to identify profanity data in the first output data using one or more machine learning models trained on pre-defined profanity data for generating the profanity score for the first output data; and determining, by the vulnerability detection subsystem, the susceptibility of the first output data based on comparing the first output data with the one or more jailbreaking test cases for generating the vulnerability score. At step 616, the computer-implemented method 600 includes executing, by the one or more servers through the performance detection subsystem, the comparative analysis between at least one of: the correctness score, the pertinence score, the similarity score, the profanity score, and the vulnerability score against the respective threshold scores to generate the performance report to determine execution performance of the one or more generative AI models. At step 618, the computer-implemented method 600 includes determining, by the one or more servers through the predictability subsystem, the probability of each consecutive action of one or more actions to execute in the first output data using the n-gram language model to evaluate the execution performance of the one or more generative AI models. In the next step, the computer-implemented method 600 includes re-evaluating, by the one or more servers through the feedback loop subsystem, the one or more generative AI models based on real-time at least one of: the input data, the AI model configurations, and the evaluation results, to generate the real-time performance reports.

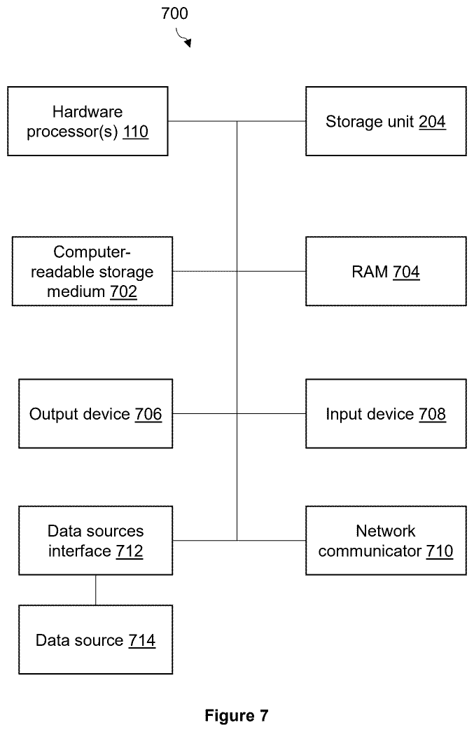

FIG. 7 illustrates an exemplary block diagram representation of a server platform 700 for implementation of the disclosed computer-implemented system, in accordance with an embodiment of the present disclosure.

In an exemplary embodiment, for the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the one or more server platforms 700. As illustrated, the one or more server platforms 700 may include additional components not shown, and some of the components described may be removed and/or modified. For example, a computer system with the multiple graphics processing units (GPUs) may be located on at least one of: internal printed circuit boards (PCBs) and external-cloud platforms including Amazon Web Services (AWS), Google Cloud Platform (GCP) Microsoft Azure (Azure), internal corporate cloud computing clusters, or organizational computing resources.

The one or more server platforms 700 may be a computer system such as the system 102 that may be used with the embodiments described herein. The computer system may represent a computational platform that includes components that may be in the one or more servers 108 or another computer system. The computer system may be executed by the one or more hardware processors 110 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the one or more hardware processors 110 that execute software instructions or code stored on a non-transitory computer-readable storage medium 702 to perform methods of the present disclosure. The software code includes, for example, instructions to gather data and analyze the network environment data. For example, the plurality of subsystems 114 includes the workflow management subsystem 206, the data obtaining subsystem 208, the context retrieval subsystem 210, the score-generating subsystem 212, the performance detection subsystem 214, and the feedback loop subsystem 216.

The instructions on the computer-readable storage medium 702 are read and stored the instructions in the storage unit or random-access memory (RAM) 704. The storage unit 204 may provide a space for keeping static data where at least some instructions could be stored for later execution. The stored instructions may be further compiled to generate other representations of the instructions and dynamically stored in the RAM 704. The one or more hardware processors 110 may read instructions from the RAM 704 and perform actions as instructed.

The computer system may further include an output device 706 to provide at least some of the results of the execution as output including, but not limited to, visual information of the performance reports to the one or more users. The output device 706 may include a display on computing devices and virtual reality glasses. For example, the display may be a mobile phone screen or a laptop screen. GUIs and/or text may be presented as an output on the display screen. The computer system may further include an input device 708 to provide the one or more users or another device with mechanisms for entering data and/or otherwise interacting with the computer system. The input device 708 may include, for example, a keyboard, a keypad, a mouse, or a touchscreen. Each of these output devices 706 and input device 708 may be joined by one or more additional peripherals.

A network communicator 710 may be provided to connect the computer system to a network and in turn to other devices connected to the network including other entities, servers, data stores, and interfaces. The network communicator 710 may include, for example, a network adapter such as a LAN adapter or a wireless adapter. The computer system may include a data sources interface 712 to access a data source 714. The data source 714 may be an information resource about the one or more generative AI models. As an example, the one or more databases 104 of exceptions and rules may be provided as the data source 714. Moreover, knowledge repositories and curated data may be other examples of the data source 714. The data source 714 may include libraries containing, but not limited to, datasets related to the one or more generative AI models, the AI model configurations, historical data, and other essential information. Moreover, the data sources interface 712 enables the system 102 to dynamically access and update these data repositories as new information is collected, analyzed, and utilized.

Numerous advantages of the present disclosure may be apparent from the discussion above. In accordance with the present disclosure, the computer-implemented system for determining execution performance of one or more generative artificial intelligence (AI) models. One significant advantage is the system's ability to conduct comprehensive evaluations of the one or more generative AI models through various subsystems, including correctness, pertinence, similarity, profanity, vulnerability, and predictability assessments. This multi-faceted approach ensures that all critical aspects of the one or more AI model's performance are scrutinized, resulting in a holistic evaluation that helps identify areas for improvement.

The real-time feedback loop is another major advantage, as it continuously re-evaluates the one or more generative AI models using real-time input data, the AI model configurations, and evaluation results. This capability ensures that the generative AI models are always adapting and improving based on the latest data, maintaining optimal performance even in dynamic and changing environments. Additionally, the predictability subsystem ensures that the generative AI models generate coherent and logical outputs by using an n-gram language model and generating a perplexity score, providing an accurate measure of the ability of the one or more generative AI models to predict consecutive actions in its outputs.

Moreover, the system provides robust security measures through the vulnerability detection subsystem, which identifies susceptibility to prompt injection and jailbreaking attacks. The vulnerability detection subsystem enhances the generative AI models resilience against adversarial threats, ensuring secure and reliable performance in sensitive applications. The profanity detection subsystem further ensures the quality of AI outputs by classifying and managing inappropriate content using machine learning models, such as XGBoost, and generating actionable profanity scores. Another technical advantage lies in the system's ability to deliver real-time performance reports in visual formats, such as radar charts, offering a clear and interpretable assessment of the execution performance of the one or more generative AI models. The performance reports are enriched with actionable recommendations, which provide the one or more users with direct guidance on optimizing model configurations and improving overall performance.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A computer-implemented system for determining an execution performance of one or more generative artificial intelligence (AI) models, comprising:
one or more servers, comprising:
one or more hardware processors; and
a memory unit operatively connected to the one or more hardware processors, wherein the memory unit comprises a set of computer-readable instructions in form of a plurality of subsystems, configured to be executed by the one or more hardware processors, wherein the plurality of subsystems comprises:
a workflow management subsystem configured to operate the one or more generative artificial intelligence (AI) models within a controlled workflow by providing input data for obtaining first output data;
a data obtaining subsystem configured to obtain at least one of: the input data, the first output data, and second output data from at least one of: the one or more generative artificial intelligence (AI) models, one or more users, and historic system data;
a context retrieval subsystem configured to retrieve context information from at least one of: the input data and the second output data stored in one or more databases, based on one or more queries provided to the one or more generative artificial intelligence (AI) models;
a score-generating subsystem, comprising:
a correctness score generation subsystem configured to determine the correctness of the one or more generative artificial intelligence (AI) models based on performing a comparative analysis between the first output data against the second output data using at least one of: a pre-trained embedding model and a pre-trained X-encoder model for generating a correctness score;
an output data pertinence determination subsystem configured to determine a pertinence of the first output data for the provided input data to the one or more generative artificial intelligence (AI) models using at least one of: a pre-trained zero-shot classifier and a clustering process, to generate a pertinence score;
an output data deviation detection subsystem configured to identify a deviation of the first output data generated by the one or more generative artificial intelligence (AI) models from the provided input data based on at least of:
the comparative analysis between the first output data and the second output data, and
the comparative analysis between the first output data and the context information, for generating a similarity score;
a profanity detection subsystem configured to analyze the first output data to identify profanity data in the first output data using one or more machine learning models trained on pre-defined profanity data for generating a profanity score for the first output data; and
a vulnerability detection subsystem configured to determine a susceptibility of the first output data based on comparing the first output data with one or more jailbreaking test cases for generating a vulnerability score; and
a performance detection subsystem configured to execute a comparative analysis between at least one of: the correctness score, the pertinence score, the similarity score, the profanity score, and the vulnerability score against respective threshold scores to generate a performance report for determining the execution performance of the one or more generative artificial intelligence (AI) models.

2. The computer-implemented system of claim 1, wherein the controlled workflow is a Retrieval Augmented Generation (RAG) workflow,
the controlled workflow is configured to retrieve the context information from the input data during the execution of the one or more generative artificial intelligence (AI) models and store in the one or more databases;
the controlled workflow is configured to assign one or more ranks to the retrieved context information for prioritizing optimal context information for generating one or more responses; and
the controlled workflow is configured to generate the one or more responses based on at least one of: the provided input data and the retrieved context information.

3. The computer-implemented system of claim 1, wherein
the input data comprises one or more of: text data, numerical data, images, audio data, and video data, provided to the one or more generative artificial intelligence (AI) models for processing;
the first output data comprises results generated by the one or more generative artificial intelligence (AI) models in response to the input data, including one or more at least one of: predicted text, classified categories, generated images, audio transcriptions, and predicted numerical values; and
the second output data comprises at least one of: a set of expected results and ground truth data, comprises at least one of: predetermined data and derived data from historical data, used to evaluate the first output data provided by the one or more generative artificial intelligence (AI) models.

4. The computer-implemented system of claim 1, wherein the context retrieval subsystem is configured to store the context information, the input data, the second output data, and the one or more queries in a form of one or more vector embeddings;
the context retrieval subsystem is configured with a cosine similarity model,
the cosine similarity model is configured to retrieve the context information based on determining a cosine angle between the one or more vector embeddings associated with the one or more queries and the one or more vector embeddings associated with the input data.

5. The computer-implemented system of claim 1, wherein the pre-trained embedding model uses the cosine similarity model to identify a contextual relationship between the first output data and the second output data for generating a semantic similarity score, and
the pre-trained X-encoder model is configured to identify an intricate relationship between the first output data and the second output data for generating an X-encoder score.

6. The computer-implemented system of claim 5, wherein the correctness score generation subsystem is further configured to regulate the semantic similarity score and the X-encoder score using a weighted combination based on a similarity threshold determined by a semantic similarity function,
wherein if the correctness score is one of: within a predefined correctness threshold score and equal to the predefined correctness threshold score, the computer-implemented system determines that the first output data is apposite with the provided input data; and
wherein if the correctness score exceeds the predefined correctness threshold score, the computer-implemented system determines that the first output data is inapt with the provided input data.

7. The computer-implemented system of claim 1, wherein the output data pertinence determination subsystem is configured to map the one or more vector embeddings associated with the input data and the one or more vector embeddings associated with the first output data into a clustered space to determine a distance between the input data and the first output data for generating the pertinence score,
if the pertinence score is one of: within a predefined pertinence threshold score and equal to the predefined pertinence threshold score, the computer-implemented system determines that the first output data is at least one of: optimal correlated and neutral, with the provided input data; and
if the pertinence score exceeds the predefined pertinence threshold score, the computer-implemented system determines that the first output data is in contradiction to the provided input data.

8. The computer-implemented system of claim 1, wherein the output data deviation detection subsystem is configured to identify a deviation of the output data based on comparing the similarity score with a predefined similarity threshold score,
if the similarity score is one of: within the predefined similarity threshold score and equal to the predefined similarity threshold score, the computer-implemented system determines that the first output data is in line with the input data; and
if the similarity score exceeds the predefined similarity threshold score, the computer-implemented system determines that the first output data is deviated from the provided input data.

9. The computer-implemented system of claim 1, wherein the pre-defined profanity data is pre-processed to convert into one or more profanity data vectors,
the profanity detection subsystem is configured to assign each profanity data vector of the one or more profanity data vectors in relation to one or more profanity classifications,
the profanity detection subsystem is configured to classify the first output data into the one or more profanity classifications by comparing the one or more vector embeddings associated with the first output data against the one or more profanity data vectors, and
the profanity detection subsystem is configured to generate the profanity score based on a number of one or more vector embeddings associated with the first output data matched with the one or more profanity data vectors associated with the one or more profanity classifications.

10. The computer-implemented system of claim 9, wherein if the profanity score is one of:
within a predefined profanity threshold score and equal to the predefined profanity threshold score, the computer-implemented system determines that the first output data is tolerable; and
wherein if the profanity score exceeds the predefined profanity threshold score, the computer-implemented system determines that the first output data contains exceptionable profanity data and triggers for at least one of: flagging and filtering, the profanity data.

11. The computer-implemented system of claim 1, wherein the one or more machine learning models comprise an accurate gradient shallow decision tree model,
the accurate gradient shallow decision tree model is configured to identify the profanity data in the first output data based on the one or more profanity data vectors.

12. The computer-implemented system of claim 1, wherein if the vulnerability score is one of: within a predefined vulnerability threshold score and equal to the predefined vulnerability threshold score, the computer-implemented system determines that the one or more generative artificial intelligence (AI) models are benign; and
wherein if the vulnerability score exceeds the predefined vulnerability threshold score, the computer-implemented system determines that the one or more generative artificial intelligence (AI) models are malignant.

13. The computer-implemented system of claim 1, wherein the performance detection subsystem is configured to generate the performance report in form at least one of: radar charts, bar charts, line charts, pie charts; scatter plots, and bubble charts,
the generated performance report comprises one or more actionable recommendations for optimizing the performance of the one or more generative artificial intelligence (AI) models based on identified at least one of: the correctness score, the pertinence score, the similarity score, the profanity score, and the vulnerability score.

14. The computer-implemented system of claim 1, wherein the threshold scores comprise at least one of: the predefined correctness threshold score, the predefined pertinence threshold score, the predefined similarity threshold score, the predefined profanity threshold score, and the predefined vulnerability threshold score.

15. The computer-implemented system of claim 1, wherein the plurality of subsystems further comprises:
a predictability subsystem configured to determine a probability of each consecutive action of one or more actions to execute in the first output data using an n-gram language model to evaluate the execution performance of one or more generative artificial intelligence (AI) models; and
a feedback loop subsystem configured to continuously re-evaluate the one or more generative artificial intelligence (AI) models based on real-time at least one of: the input data, artificial intelligence (AI) model configurations, and evaluation results, for generating real-time performance reports.

16. The computer-implemented system of claim 15, wherein the predictability subsystem is configured to:
train the n-gram language model on the input data;
determine the probability of each consecutive action of the one or more actions using trained n-gram language model to generate a perplexity score;
normalize the generated perplexity score to a defined perplexity range;
if the perplexity score is one of: within a predefined perplexity threshold score of the defined perplexity range and equal to the predefined perplexity threshold score of the defined perplexity range, the computer-implemented system determines that the probability of predicting each consecutive action of one or more actions is superior; and
if the perplexity score exceeds the predefined perplexity threshold score of the defined perplexity range, the computer-implemented system determines the probability of predicting each consecutive action of one or more actions is inferior.

17. A computer-implemented method for determining an execution performance of one or more generative artificial intelligence (AI) models, comprising:
operating, by one or more servers through a workflow management subsystem, the one or more generative artificial intelligence (AI) models within a controlled workflow by providing input data to obtain first output data;
obtaining, by the one or more servers through a data obtaining subsystem, at least one of: the input data, the first output data, and second output data from at least one of: the one or more generative artificial intelligence (AI) models, one or more users, and historic system data;
retrieving, by the one or more servers through a context retrieval subsystem, context information from at least one of: the input data and the second output data stored in one or more databases, based on one or more queries provided to the one or more generative artificial intelligence (AI) models;
generating, by the one or more servers through a score-generating subsystem, comprises:
determining, by a correctness score generation subsystem, the correctness of the one or more generative artificial intelligence (AI) models based on performing a comparative analysis between the first output data against the second output data using at least one of: a pre-trained embedding model and a pre-trained X-encoder model for generating a correctness score;
determining, by an output data pertinence determination subsystem, a pertinence of the first output data for the provided input data to the one or more generative artificial intelligence (AI) models using at least one of: a pre-trained zero-shot classifier and a clustering process, to generate a pertinence score;
identifying, by an output data deviation detection subsystem, a deviation of the first output data generated by the one or more generative artificial intelligence (AI) models from the provided input data based on at least one of:
the comparative analysis between the first output data and the second output data, and
the comparative analysis between the first output data and the context information, for generating a similarity score;
analyzing, by a profanity detection subsystem, the first output data to identify profanity data in the first output data using one or more machine learning models trained on pre-defined profanity data for generating a profanity score for the first output data; and
determining, by a vulnerability detection subsystem, a susceptibility of the first output data based on comparing the first output data with one or more jailbreaking test cases for generating a vulnerability score; and
executing, by the one or more servers through a performance detection subsystem, a comparative analysis between at least one of: the correctness score, the pertinence score, the similarity score, the profanity score, and the vulnerability score against respective threshold scores to generate a performance report to determine the execution performance of the one or more generative artificial intelligence (AI) models.

18. The computer-implemented method of claim 17, further comprising:
determining, by the one or more servers through a predictability subsystem, a probability of each consecutive action of one or more actions to execute in the first output data using an n-gram language model to evaluate the execution performance of the one or more generative artificial intelligence (AI) models; and
re-evaluating, by the one or more servers through a feedback loop subsystem, the one or more generative artificial intelligence (AI) models based on real-time at least one of: the input data, artificial intelligence (AI) model configurations, and evaluation results, to generate real-time performance reports.

19. A non-transitory computer-readable storage medium storing computer-executable instructions that, when executed by one or more hardware processors, cause the one or more hardware processors to perform operations for determining an execution performance of one or more generative artificial intelligence (AI) models, the operations comprising:
operating the one or more generative artificial intelligence (AI) models within a controlled workflow by providing input data to obtain first output data;
obtaining at least one of: the input data, the first output data, and second output data from at least one of: the one or more generative artificial intelligence (AI) models, one or more users, and historic system data;
retrieving context information from at least one of: the input data and the second output data stored in one or more databases, based on one or more queries provided to the one or more generative artificial intelligence (AI) models;
determining the correctness of the one or more generative artificial intelligence (AI) models based on performing a comparative analysis between the first output data against the second output data using at least one of: a pre-trained embedding model and a pre-trained X-encoder model for generating a correctness score;
determining a pertinence of the first output data for the provided input data to the one or more generative artificial intelligence (AI) models using at least one of: a pre-trained zero-shot classifier and a clustering process, to generate a pertinence score;
identifying a deviation of the first output data generated by the one or more generative artificial intelligence (AI) models from the provided input data based on at least one of:
the comparative analysis between the first output data and the second output data, and
the comparative analysis between the first output data and the context information, for generating a similarity score;
analyzing the first output data to identify profanity data in the first output data using one or more machine learning models trained on pre-defined profanity data for generating a profanity score for the first output data;
determining a susceptibility of the first output data based on comparing the first output data with one or more jailbreaking test cases for generating a vulnerability score; and
executing a comparative analysis between at least one of: the correctness score, the pertinence score, the similarity score, the profanity score, and the vulnerability score against respective threshold scores to generate a performance report to determine the execution performance of the one or more generative artificial intelligence (AI) models.

20. The non-transitory computer-readable storage medium of claim 19, further comprising:
determining, by the one or more servers through a predictability subsystem, a probability of each consecutive action of one or more actions to execute in the first output data using an n-gram language model to evaluate the execution performance of one or more generative artificial intelligence (AI) models; and
re-evaluating, by the one or more servers through a feedback loop subsystem, the one or more generative artificial intelligence (AI) models based on real-time at least one of: the input data, artificial intelligence (AI) model configurations, and evaluation results, to generate real-time performance reports.
